(19) United States
(12) Patent Application Publication
(10) Pub. No.: US 2013/0024773 A1
(43) Pub. Date: Jan. 24, 2013

(54) SYSTEM AND METHOD FOR SUMMARIZING INTERACTIONS

(71) Applicants: Puneet Gupta, Bangalore (IN); Akshay Darbari, Bangalore (IN)

(72) Inventors: Puneet Gupta, Bangalore (IN); Akshay Darbari, Bangalore (IN)

(73) Assignee: INFOSYS LIMITED, Bangalore (IN)

(21) Appl. No.: 13/344,600

(22) Filed: Jan. 5, 2012

(30) Foreign Application Priority Data
Jul. 19, 2011 (IN) 2452/CHE/2011

(51) Int. Cl. G06F 3/01

(52) U.S. Cl. 715/730

(57) ABSTRACT

The disclosed embodiment relates to methods for presenting information to a user in a concise manner. The method preferably comprises receiving information specifying at least one data characteristic and at least one presentation characteristic, wherein the at least one data characteristic relates to information desired by a user regarding data and the at least one presentation characteristic relates to the manner in which information is presented to the user, receiving a collection of data, identifying relevant data from the collection of data based on at least one of the data characteristics, condensing the relevant data into presentation data based on at least one of the presentation characteristics, and presenting the presentation data. The disclosed embodiment also relates to a system and computer-readable code that can be used to implement the exemplary methods.

### RELATED APPLICATION DATA

This application claims priority to Indian Patent Application No. 2452/CHE/2011, filed Jul. 19, 2011, which is hereby incorporated by reference in its entirety.

### FIELD OF THE INVENTION

The invention relates to a system and method for presenting information to a user in a concise manner.

### BACKGROUND

Data that is presented to a user can be overwhelming simply because of how much data is presented. Such data can be obtained from any source, such as the internet, intranets or local networks, a user machine, and the like. Thus, interactions, such as web interactions, can be monotonous and boring if the user has to follow the same process for an interaction again and again and for a long duration.

For dynamic content, it is difficult to keep track the current status of the content as the content may be constantly changing. Making decisions based on the knowledge derived from dynamic content can be very difficult and time consuming.

### SUMMARY

The disclosed embodiment relates to a computer-implemented method for presenting information to a user in a concise manner. The method preferably comprises receiving information specifying at least one data characteristic and at least one presentation characteristic, wherein the at least one data characteristic relates to information desired by a user regarding data and the at least one presentation characteristic relates to the manner in which information is presented to the user, receiving a collection of data, identifying relevant data from the collection of data based on at least one of the data characteristics, condensing the relevant data into presentation data based on at least one of the presentation characteristics, and presenting the presentation data.

The disclosed embodiment further relates to a system for presenting information to a user in a concise manner. The system preferably comprises a computing device configured to receive information specifying at least one data characteristic and at least one presentation characteristic, wherein the at least one data characteristic relates to information desired by a user regarding data and the at least one presentation characteristic relates to the manner in which information is presented to the user, a computing device configured to receive a collection of data, a computing device configured to identify relevant data from the collection of data based on at least one of the data characteristics, a computing device configured to condense the relevant data into presentation data based on at least one of the presentation characteristics, and a computing device configured to present the presentation data.

The disclosed embodiment also relates to computer-readable code stored on a non-transitory computer-readable medium that, when executed by a mobile device, performs a method for presenting information to a user in a concise manner. The method preferably comprises receiving information specifying at least one data characteristic and at least one presentation characteristic, wherein the at least one data characteristic relates to information desired by a user regarding data and the at least one presentation characteristic relates to the manner in which information is presented to the user, receiving a collection of data, identifying relevant data from the collection of data based on at least one of the data characteristics, condensing the relevant data into presentation data based on at least one of the presentation characteristics, and presenting the presentation data.

As described herein, the data characteristics may relate to the type of data desired by the user, to an entity associated with the data desired by the user, and the like. In addition, the collection of data may include data collected over a period of time, and the data characteristics may relate to the period of time over which the data is collected. Furthermore, the presentation characteristics may relate to the format in which the data is presented to the user, to the size or duration of the data presented to the user, and the like. Moreover, the collection of data may include data related to a plurality of interactions, and the interactions may include web interactions. The presentation data may also be presented in the form of a story.

### BRIEF DESCRIPTION OF THE DRAWINGS

FIG. 1 is a flowchart illustrating the general components of a story.

FIG. 2 is a flowchart illustrating the steps of a method in accordance with the disclosed embodiment.

FIG. 3 is a flowchart illustrating the steps of a method for presenting data in accordance with the disclosed embodiment.

FIG. 4 illustrates an exemplary computing device useful for implementing systems and performing methods disclosed herein.

### DETAILED DESCRIPTION

The disclosed embodiments relate to techniques for recording interaction and dynamic data, such as web-based or other types of interactions, and automatically presenting the resulting data sets to users in a concise form. Summarization is a powerful tool to achieve this form of representation. Summarization, in this context, refers to a process of selecting set of meaningful (interaction and its result) information to represent conventional user interaction and content, generated out of these interactions.

However, by simply generating interaction summaries, the resulting presentation may include multiple fragments of disconnected summaries. In order to generate a single meaningful summary, it is advantageous to weave a story out of all summary fragments and connect them in a useful and accurate fashion. The disclosed embodiments utilize a storytelling technique to effectively and convincingly communicate interaction summary to the user.

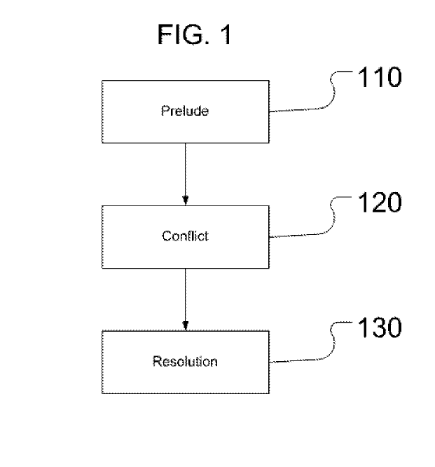

Generally, as is shown in FIG. 1, a story consists of three parts: the beginning (prelude or exposition) 110, the middle (conflict) 120, and the end (resolution) 130. The beginning introduces basic facts such as context, characters, and their relationships, which are needed to establish the story. Then, the story develops when conflicts among characters occur, which are usually expressed in the form of an internal or external action. Finally, the resolution resolves the conflict by wrapping up all incomplete story elements.

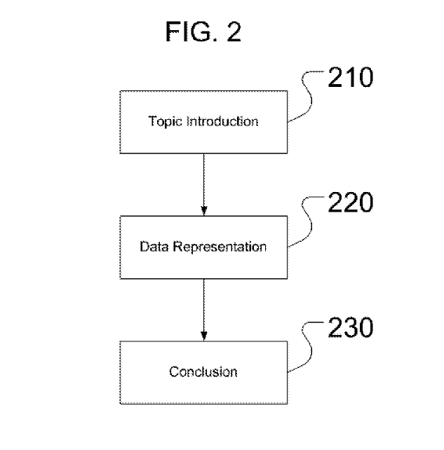

Using the general organizational form of a story, FIG. 2 illustrates how content summarization can be implemented by dividing topics or interactions into three parts: an introductory part 210, which explains the interaction, a dynamic data generation and representation based on the context 220, and a conclusion 230 based on results of the dynamic data generation and representation. While the embodiments herein refer to web content or data by example, the methods of the disclosed embodiments can be applied to any type of content or data.

These steps can be presented in a form similar to a free flowing story. Topic introduction 210 and conclusion 230 will generally have a finite set of possible results, the middle portion, data representation 220, is generally unpredictable as it preferably depends on dynamic data streams.

For example, suppose a user keeps a close watch on the stock market and at the end of each day decides his investment plans. In order to ensure accuracy, the user may need to monitor and collate stock market data throughout the day before making any decisions. This process would be much more efficient if the user could simply review a daily summary rather than having to track the stocks constantly.

The outcome possibilities for the parts shown in FIG. 2 are set forth below for the above scenario:

Topic Introduction 210: This portion introduces the topic, such as whether the stock market surged, remained stable, crashed, etc.

Data Representation 220: This portion depends on the live stock data coming in over the course of the day. As such, the data is dynamically collected and analyzed to determine whether there were any market surges, crashes, or other variations or market trends.

Conclusion 230: This portion provides the user with recommendations, such as whether the user should sell, hold, or buy stocks.

After executing these steps, the content for the story is available, however, the presentation of the story is equally important. A strong setting to communicate this or similar story would be a news room scenario. As stated earlier, possibilities of the introductory and conclusory steps are generally known, and, in some circumstances, can be pre-recorded, for example, in audio-visual. However, based on the data, the right possibility would be picked on the fly and the second part would generate a summary of the interaction dynamically. Putting all of the steps together forms a complete continuous free flowing story which makes sense to the user. This concept can be extended to any type of interaction or data exchange and would prove to be an effective and efficient way of presenting information more efficiently.

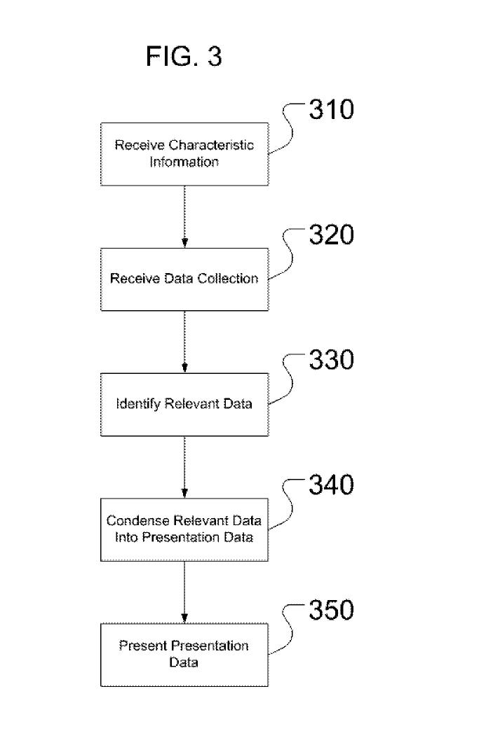

FIG. 3 illustrates an exemplary method according to the disclosed embodiment. In step 310, information specifying at least one data characteristic and at least one presentation characteristic is received. The data characteristics preferably relate to information desired by a user regarding data. Examples of data characteristics include, for example, the type of data desired by the user, an entity associated with the data desired by the user, and the like. Thus, in the stock market example, data characteristics could include only stocks associated with a particular company, stocks associate with a particular industry, stocks valued at a certain price, etc. The presentation characteristics preferably relate to the manner in which information is presented to the user. Examples of presentation characteristics includes, for example, the format in which the data is presented to the user, the size or duration of the data presented to the user, the level of detail desired by the user, and the like. These characteristics are preferably provided by the user, but may be pre-determined or obtained through other means or automatically.

In step 320, a collection of data is received. In the alternative, the data may be collected in real-time, at specific intervals, over a specified period of time, etc. In one embodiment, the collection of data includes dynamic data, for example, stock market data. Then, in step 330, the collection of data is analyzed to determine which portions of the data are relevant based on one or more of the data characteristics. This analysis can include any type of filtering, etc., to identify the relevant data from the entirety of the collection of data.

After the relevant data has been identified, the relevant data is condensed into presentation data in step 340 based on one or more of the presentation characteristics. For example, if one of the presentation characteristics specifies that the duration of the presentation will be limited to a text document having a maximum size, for example, one page, the relevant data is preferably condensed into form that satisfies this characteristic, if possible.

The presentation data is then presented to the user in step 350. As indicated above, the presentation data can be presented to the user in any form consistent with the presentation characteristics. For example, the presentation may occur in any format, including text, document, html, graphics, images, audio, video, etc.

Thus, as described above, the disclosed embodiments relate to managing interactions, such as web interactions, by utilizing summarization and storytelling techniques. A concise summary is automatically generated for interactions and is effectively and convincingly communicated through a news room scenario by making use of media technology for appropriate representation. Other ways to present the summary and other information include, for example, text (e.g. in a form of a press release/news/presentation etc.), audio (e.g. in the form of radio program/news/commentary), video (e.g. in the form of TV program/series/news/documentary/commentary etc.), graphical (e.g. in the form of a comic/sequence of static pictures with voice over etc.), and the like. Furthermore, the effectiveness of the presentation of the summary would depend on the type of data presented and the output format chosen. For example, for video data, a news room scenario might be effective, but for text data, a press release or a presentation (such as PowerPoint) would be a more suitable presentation format. Furthermore, presenting the same or similar data in different formats can be very advantageous.

In addition, any aspect of the summary or story (i.e. the topic introduction, the data representation, and the conclusion) and any representations of the interactions themselves may also be presented in any suitable format as described above. Exemplary suitable formats include, for example, text (e.g. in a form of a press release/news/presentation etc.), audio (e.g. in the form of radio program/news/commentary), video (e.g. in the form of TV program/series/news/documentary/commentary etc.), graphical (e.g. in the form of a comic/sequence of static pictures with voice over etc.), and the like. The optimal format is generally determined based on the context or the input.

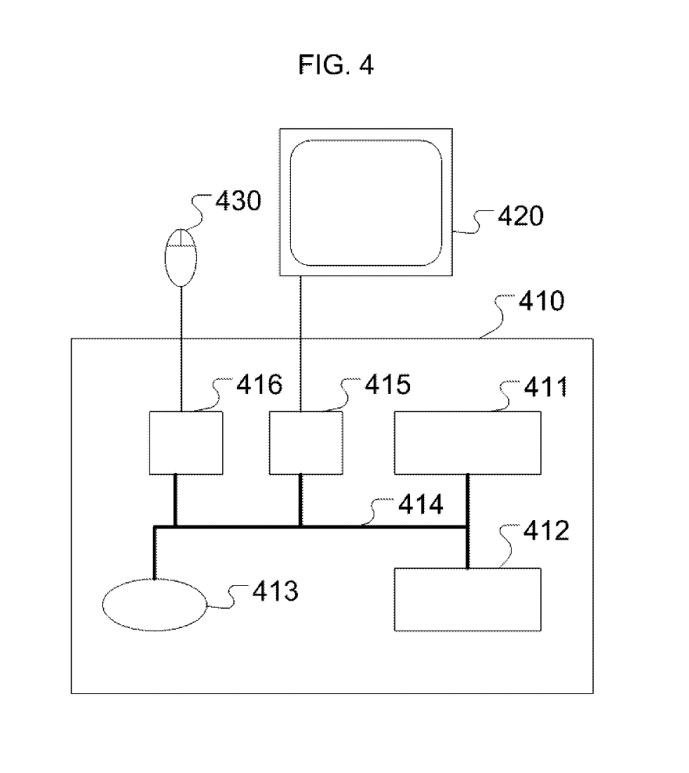

The embodiments described herein may be implemented with any suitable hardware and/or software configuration, including, for example, modules executed on computing devices such as computing device 410 of FIG. 4. Embodiments may, for example, execute modules corresponding to steps shown in the methods described herein. Of course, a single step may be performed by more than one module, a single module may perform more than one step, or any other logical division of steps of the methods described herein may be used to implement the processes as software executed on a computing device.

Computing device 410 has one or more processing device 411 designed to process instructions, for example computer readable instructions (i.e., code) stored on a storage device 413. By processing instructions, processing device 411 may perform the steps set forth in the methods described herein. Storage device 413 may be any type of storage device (e.g., an optical storage device, a magnetic storage device, a solid state storage device, etc.), for example a non-transitory storage device. Alternatively, instructions may be stored in remote storage devices, for example storage devices accessed over a network or the internet. Computing device 410 additionally has memory 412, an input controller 416, and an output controller 415. A bus 414 operatively couples components of computing device 410, including processor 411, memory 412, storage device 413, input controller 416, output controller 415, and any other devices (e.g., network controllers, sound controllers, etc.). Output controller 415 may be operatively coupled (e.g., via a wired or wireless connection) to a display device 420 (e.g., a monitor, television, mobile device screen, touch-display, etc.) in such a fashion that output controller 415 can transform the display on display device 420 (e.g., in response to modules executed). Input controller 416 may be operatively coupled (e.g., via a wired or wireless connection) to input device 430 (e.g., mouse, keyboard, touch-pad, scroll-ball, touch-display, etc.) in such a fashion that input can be received from a user (e.g., a user may input with an input device 430 a dig ticket). The system can also utilize external peripherals including printers, external HDD/storage devices, projectors, and the like.

Of course, FIG. 4 illustrates computing device 410, display device 420, and input device 430 as separate devices for ease of identification only. Computing device 410, display device 420, and input device 430 may be separate devices (e.g., a personal computer connected by wires to a monitor and mouse), may be integrated in a single device (e.g., a mobile device with a touch-display, such as a Smartphone or a tablet), or any combination of devices (e.g., a computing device operatively coupled to a touch-screen display device, a plurality of computing devices attached to a single display device and input device, etc.). Computing device 410 may be one or more servers, for example a farm of networked servers, a clustered server environment, or a cloud network of computing devices.

While systems and methods are described herein by way of example and embodiments, those skilled in the art recognize that the systems and methods for presenting information to a user are not limited to the embodiments or drawings described. It should be understood that the drawings and description are not intended to be limiting to the particular form disclosed. Rather, the intention is to cover all modifications, equivalents and alternatives falling within the spirit and scope of the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

Various embodiments of the disclosed embodiment have been disclosed herein. However, various modifications can be made without departing from the scope of the embodiments as defined by the appended claims and legal equivalents.

What is claimed is:

1. A computer-implemented method for presenting information to a user in a concise manner, the method comprising:
receiving, by a computing device, information specifying at least one data characteristic and at least one presentation characteristic, wherein the at least one data characteristic relates to information desired by a user regarding data and the at least one presentation characteristic relates to the manner in which information is presented to the user;
receiving, by a computing device, a collection of data;
identifying, by a computing device, relevant data from the collection of data based on at least one of the data characteristics;
condensing, by a computing device, the relevant data into presentation data based on at least one of the presentation characteristics; and
presenting, by a computing device, the presentation data.

2. The method of claim 1, wherein at least one of the data characteristics relates to the type of data desired by the user.

3. The method of claim 1, wherein at least one of the data characteristics relates to an entity associated with the data desired by the user.

4. The method of claim 1, wherein the collection of data includes data collected over a period of time, and at least one of the data characteristics relates to the period of time over which the data is collected.

5. The method of claim 1, wherein at least one of the presentation characteristics relates to the format in which the data is presented to the user.

6. The method of claim 1, wherein at least one of the presentation characteristics relates to the size or duration of the data presented to the user.

7. The method of claim 1, wherein the collection of data includes data related to a plurality of interactions.

8. The method of claim 7, wherein at least one of the interactions is a web interaction.

9. The method of claim 1, wherein the presentation data is presented in the form of a story.

10. A system for presenting information to a user in a concise manner, the system comprising:
a computing device configured to receive information specifying at least one data characteristic and at least one presentation characteristic, wherein the at least one data characteristic relates to information desired by a user regarding data and the at least one presentation characteristic relates to the manner in which information is presented to the user;
a computing device configured to receive a collection of data;
a computing device configured to identify relevant data from the collection of data based on at least one of the data characteristics;
a computing device configured to condense the relevant data into presentation data based on at least one of the presentation characteristics; and
a computing device configured to present the presentation data.

11. The system of claim 10, wherein at least one of the data characteristics relates to the type of data desired by the user.

12. The system of claim 10, wherein at least one of the data characteristics relates to an entity associated with the data desired by the user.

13. The system of claim 10, wherein the collection of data includes data collected over a period of time, and at least one of the data characteristics relates to the period of time over which the data is collected.

14. The system of claim 10, wherein at least one of the presentation characteristics relates to the format in which the data is presented to the user.

15. The system of claim 10, wherein at least one of the presentation characteristics relates to the size or duration of the data presented to the user.

16. The system of claim 10, wherein the collection of data includes data related to a plurality of interactions.

17. The system of claim 16, wherein at least one of the interactions is a web interaction.

18. The system of claim 10, wherein the presentation data is presented in the form of a story.

19. Computer-readable code stored on a non-transitory computer-readable medium that, when executed by a mobile device, performs a method for presenting information to a user in a concise manner, the method comprising:
receiving, by a computing device, information specifying at least one data characteristic and at least one presentation characteristic, wherein the at least one data characteristic relates to information desired by a user regarding data and the at least one presentation characteristic relates to the manner in which information is presented to the user;
receiving, by a computing device, a collection of data;
identifying, by a computing device, relevant data from the collection of data based on at least one of the data characteristics;
condensing, by a computing device, the relevant data into presentation data based on at least one of the presentation characteristics; and
presenting, by a computing device, the presentation data.

20. The computer-readable code of claim 19, wherein at least one of the data characteristics relates to the type of data desired by the user.

21. The computer-readable code of claim 19, wherein at least one of the data characteristics relates to an entity associated with the data desired by the user.

22. The computer-readable code of claim 19, wherein the collection of data includes data collected over a period of time, and at least one of the data characteristics relates to the period of time over which the data is collected.

23. The computer-readable code of claim 19, wherein at least one of the presentation characteristics relates to the format in which the data is presented to the user.

24. The computer-readable code of claim 19, wherein at least one of the presentation characteristics relates to the size or duration of the data presented to the user.

25. The computer-readable code of claim 19, wherein the collection of data includes data related to a plurality of interactions.

26. The computer-readable code of claim 25, wherein at least one of the interactions is a web interaction.

27. The computer-readable code of claim 19, wherein the presentation data is presented in the form of a story.
